(19) United States
(12) Patent Application Publication
(10) Pub. No.: US 2017/0222960 A1
(43) Pub. Date: Aug. 3, 2017

(54) SPAM PROCESSING WITH CONTINUOUS MODEL TRAINING

(71) Applicant: LinkedIn Corporation, Mountain View, CA (US)

(72) Inventors: Siddharth Agarwal, Sunnyvale, CA (US); Anindita Gupta, Sunnyvale, CA (US); Siddharth Sodhani, Bengaluru (IN); Nishant Gaurav, Patna (IN); Dan Shacham, Sunnyvale, CA (US); Shivakumar Edayathumangalam Raman, Bangalore (IN)

(21) Appl. No.: 15/012,357

(22) Filed: Feb. 1, 2016

(51) Int. Cl. H04L 12/58; G06N 99/00

(52) U.S. Cl. CPC H04L 51/12; G06N 99/005

(57) ABSTRACT

In various example embodiments, a system and method for generating a filtering spam content using machine learning are presented. One or more electronic content is received. The one or more electronic content is labeled as spam or not spam by a current spam filtering system. An associated accuracy score for each of the one or more labeled content is calculated. Potential errors in the one or more labeled content is identified based on the label of the one or more labeled content being inconsistent with information associated with the source of the one or more labeled content. The one or more labeled content with identified potential errors is sent for assessment. The one or more electronic content labeled as spam with an associated accuracy score within a predetermined range is filtered, excluding labeled content with identified potential errors.

### TECHNICAL FIELD

Embodiments of the present disclosure relate generally to data processing, and data analysis, and, more particularly, but not by way of limitation, to spam processing with continuous model training and machine learning.

### BACKGROUND

The use of electronic messaging systems to send spam messages (mass mailing of unsolicited messages) is an increasingly prevalent problem and comes at a great cost to users, including fraud, theft, loss of time and productivity, and the like. Current spam filtering techniques rely on the presence or absence of words to indicate that the content is spam. However, spam content are continually changing and becoming more intelligent and aggressive in order to avoid such spam filtering techniques. As a result, these spam filtering techniques becomes increasingly less effective at filtering the malicious content over time, leading to increasing exposure to these malicious spam, such as the fraudulent schemes often attached to spam email.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system within which various example embodiments may be deployed.

FIG. 2 is a block diagram depicting an example embodiment of a spam processing system, according to some example embodiments.

FIG. 3 is a block diagram illustrating spam labeling and data collection of a spam processing system, according to some example embodiments.

FIG. 4 is a block diagram illustrating building, training, and updating machine learning spam processing models, according to example embodiments.

FIG. 5 is a flow diagram illustrating an example method for building, training, and updating machine learning spam processing filters, according to example embodiments.

FIG. 6 is a flow diagram illustrating updating labeled content, according to example embodiments.

FIG. 7 is a flow diagram illustrating data collection and labelling content for use in training machine learning spam filtering models, according to example embodiments.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The features of the present disclosure provide a technical solution to the technical problem of smart spam content is constantly changing rendering spam filtering models unable to effectively filter the changed spam content. In example embodiments, a spam filtering system provides the technical benefit of generating a spam filtering framework utilizing machine learning to adapt and constantly train the spam filtering model to effectively filter new spam content.

While the term spam is used herein refers to certain types of spam content such as electronic mail, this term is used in its broadest sense, and therefore, includes all types of unsolicited message content sent repeatedly on the same web site. The term spam content applies to other media such as: instant messaging spam, newsgroup spam, web search engine spam, spam in blogs , online classified ads spam, mobile device messaging spam, internet forum spam, fax transmissions, online social media spam, television advertising spam, and the like.

In various embodiments, systems and methods for spam processing using machine learning are described. In various embodiments, the features of the present disclosure provide a technical solution to the technical problem of providing spam processing with machine learning. Current spam content are continually changing and being updated to avoid spam filtering systems. Accordingly, in some embodiments, spam filtering systems are created to employ machine learning in order to continuously update and aggressively filter new spam content, thus keeping the spam filtering system current with the times. In example embodiments, a spam filtering system employs a current spam filtering system that labels incoming content with an assigned associated accuracy score. Potential errors in the labeling content are identified based on the labeling being inconsistent with information associated with the source of the labeled content. Further, the content with the identified potential errors are subsequently sent for further assessment by expert reviewers. Within the remaining content, the content being labeled as spam with an associated accuracy score within a predetermined range are filtered. The predetermined range signifies a high confidence in the labeling. Further, other labeled content are also sent for further review and labeling for the purpose of data collection and subsequent spam model training. These labeled content that have been reviewed are used to generate potential spam models. The performance of the potential spam models are calculated using a performance score based on precision and recall statistics along with other types of model evaluation statistics. The potential spam model with the highest performance score is used to compare with the current spam model. If the potential spam model has a higher performance score, then the potential spam model replaced the current spam model as the active spam filtering system. If no potential spam model performs better than the current spam model, the system continues to collect new data and train other potential spam models.

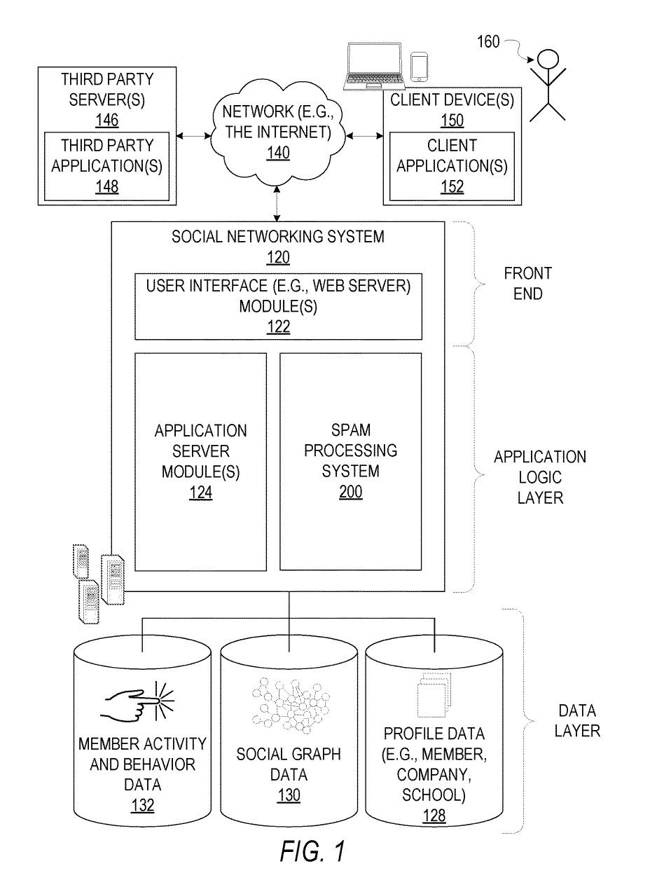

As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, Application Programming Interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOSTM, Android™ Windows® Phone). For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 120, information relating to the member's activity and behavior may be stored in a database, such as the database 132. The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include spam processing system 200, which is described in more detail below.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

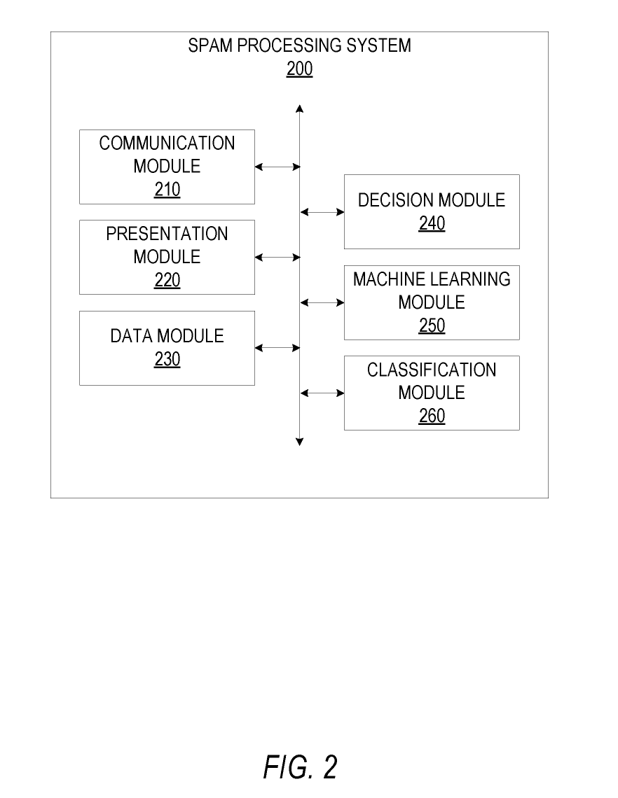

FIG. 2 is a block diagram illustrating components provided within the spam processing system 200, according to some example embodiments. The spam processing system 200 includes a communication module 210, a presentation module 220, a data module 230, a decision module 240, machine learning module 250, and classification module 260. All, or some, of the modules are configured to communicate with each other, for example, via a network coupling, shared memory, a bus, a switch, and the like. It will be appreciated that each module may be implemented as a single module, combined into other modules, or further subdivided into multiple modules. Any one or more of the modules described herein may be implemented using hardware (e.g., a processor of a machine) or a combination of hardware and software. Other modules not pertinent to example embodiments may also be included, but are not shown.

The communication module 210 is configured to perform various communication functions to facilitate the functionality described herein. For example, the communication module 210 may communicate with the social networking system 120 via the network 140 using a wired or wireless connection. The communication module 210 may also provide various web services functions such as retrieving information from the third party servers 146 and the social networking system 120. In this way, the communication module 220 facilitates the communication between the recruiting system 200 with the client devices 150 and the third party servers 146 via the network 140. Information retrieved by the communication module 210 may include profile data corresponding to the user 160 and other members of the social network service from the social networking system 120.

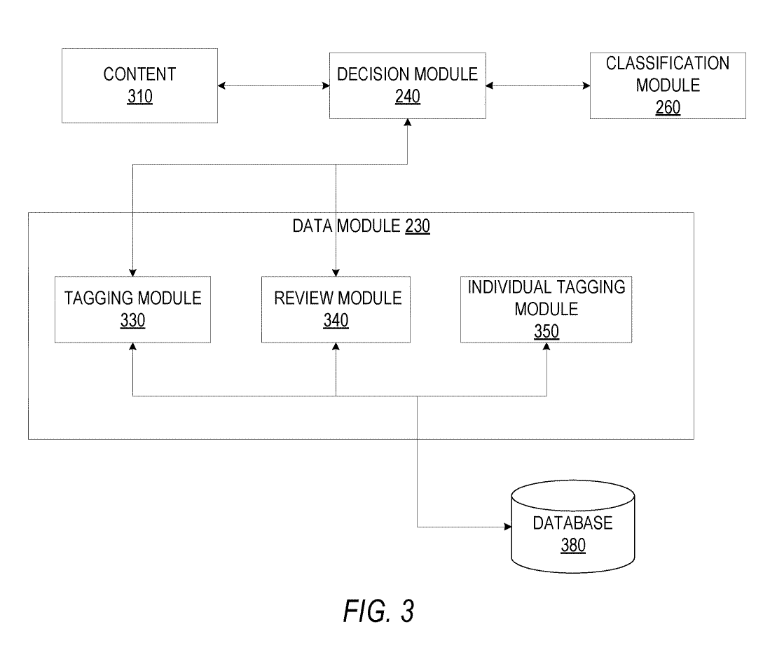

In some implementations, the presentation module 220 is configured to present an interactive user interface to various individuals for labelling received content as potential spam. The various individuals can be trained internal reviewers at the tagging module 330, expert reviewers for labelling content at the review module 340, individual members of a social network (e.g., members using the professional network LinkedIn, in one example), or individual people from a broad online community via crowdsourcing platforms (e.g., using CrowdFlower crowdsourcing platform, in one example). Each of the reviewing and labeling process is further detailed in association with FIG. 3. In various implementations, the presentation module 220 presents or causes presentation of information (e.g., visually displaying information on a screen, acoustic output, haptic feedback). Interactively presenting information is intended to include the exchange of information between a particular device and the user of that device. The user of the device may provide input to interact with a user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors), and the like. It will be appreciated that the presentation module 220 provides many other user interfaces to facilitate functionality described herein. Further, it will be appreciated that “presenting” as used herein is intended to include communicating information or instructions to a particular device that is operable to perform presentation based on the communicated information or instructions via the communication module 210, data module 230, and decision module 240, machine learning module 250, and classification module 260. The data module 230 is configured to provide various data functionality such as exchanging information with databases or servers.

The data module 230 collects spam sampling data for the machine learning module 250 in various ways including review and labeling of content at the tagging module 330, review module 350, and individual tagging module 350 as further discussed below in detail. In some implementations, the data module 230 includes the tagging module 330, review module 340, and individual tagging module 350. It will be appreciated that each module may be implemented as a single module, combined into other module, or further subdivided into multiple module. Any one or more of the module described herein may be implemented using hardware (e.g., a processor of a machine) or a combination of hardware and software. Other module not pertinent to example embodiments may also be included, but are not shown. Further details associated with the data module 230, according to various example embodiments, are discussed below is association with FIG. 3.

The decision module 240 receives labeled content from the classification module 260, where the classification module 260 has labeled the content within the spam, low quality spam, or not spam category. The decision module 240 receives content labeled by the classification module 260 with an associated accuracy score. Based on the accuracy score falling within a predetermined range, the decision module 240 sends the content to the tagging module 330 for further review and labeling of the content. In some embodiments, the decision module 240 determines whether the labeling of the content by the classification module 260 is questionable (e.g., the labels are potentially erroneous due to detected inconsistencies). Where the labelling of the content by the classification module 260 is determined questionable, the content is sent to the review module 340 for further review by an expert reviewer. Content that are labeled spam and low quality spam with a higher accuracy score and not sent to the review module 340 are filtered by the decision module 240. Further details associated with the decision module 240, according to various example embodiments, are discussed below is association with FIG. 3.

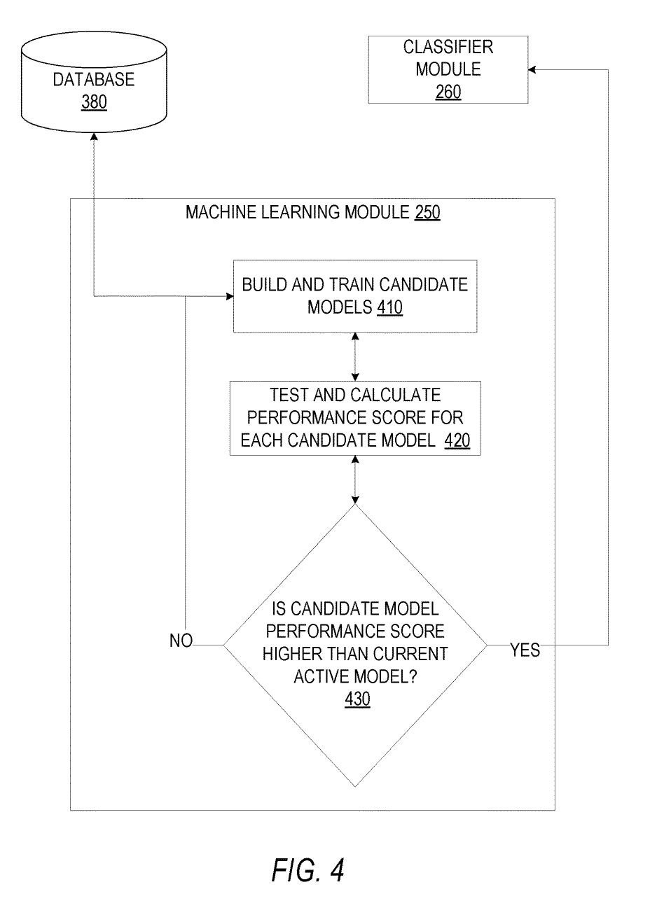

The machine learning module 250 provides functionality to access the labeled data from the database 380 and data module 230 in order to construct a candidate model and test the model. The machine learning module 250 further evaluates whether the candidate model is better than the current spam filtering model using F-measure, ROC-AUC (receiver operating characteristic-area under the ROC curve), or accuracy statistics. If the candidate model is determined to perform better than the current spam filtering model, then the system actives the candidate model and apply it as the active model for spam filtering. If the candidate model does not perform better, more labeled data is used to further train the candidate model. In this way, the candidate model has no impact on the current spam filtering model until the model becomes better at filtering spam than the current model. In other words, the candidate model is still in a passive state, where the classifiers of the passive state do not have any impact on the current model. Where the candidate model is determined to be better than the current spam filtering model, then the candidate model is used, thus transitioning the candidate model from a passive state to an active state. The passive state of the candidate model allows the system to create a better spam filtering model without incurring the mistakes of the candidate module along the way. The candidate model would be sent to the classification module 260 for application to current spam after the machine learning module determines that the candidate module is better the current model running on the classification module 260. Further details associated with the machine learning module 250, according to various example embodiments, are discussed below is association with FIG. 4.

The classification module 260 provides functionality to label incoming content within the categories: spam, low quality spam content, or not spam. The classification module applies a current active spam filtering model and label and filter spam content. The classification module 260 labels the content by applying current spam filtering rules to the incoming content 310 including content filters, header filters, general blacklist filters, rule-based filters, and the like. In addition to the labeled categories, the classification module 260 further flags the content 310 with spam type identifiers including, but not limited to: adult, money fraud, phishing, malware, commercial spam, hate speech, harassment, outrageously shocking, and the like. Within the low quality content category, the classification module 260 further flags the content 310 with low quality identifiers, including, but not limited to: adult (the level of low quality adult is not as outrageous as compared to the spam type adult), commercial promotions, unprofessional, profanity, shocking, and the like. Any other content not identified with the spam type identifiers or low quality identifiers are not spam. As a result, content within the spam category are undesirable content that are potentially harmful and therefore rigorous filtering is necessary. Content within the low quality spam category are also undesirable content and potentially offensive in nature. Content within the not spam category are desirable content that are not filtered and allowed to be presented to a user. Further details associated with the classification module 260, according to various example embodiments, are discussed below is association with FIG. 3 and FIG. 4.

FIG. 3 is a block diagram illustrating an example of spam labeling and data collection of the spam processing system 200. One aspect of the spam processing system 200 is to acquire a training data set to train a test model with the purpose of keeping the spam filtering up to date by updating and building increasingly better spam filtering models. The training data set is acquired by the data module 230 and stored in the database 380.

In some implementations, the decision module 240 receives content 310 and sends the content 310 to the classification module 260 where a current spam filtering model is applied to label content 310. The content 310 includes any electronic content that may be potentially a spam. For example, content 310 can include email, user posting, advertisements, an article posted by a user, and the like. Each content 310 includes a source identifier to identify where the content 310 originated. For example, a source identifier can include an article by a member named Sam Ward. Content 310 is received by the classification module 260, where a current active spam filtering model is used by the classification module 260 to label the content 310. The classification module 260 labels the content by applying current spam filtering rules to the incoming content 310 including content filters, header filters, general blacklist filters, rule-based filters, and the like. Content filters review the content within the message and identifies words and sentences and flag the content as spam. Header filters review the content title identifying spam information. A general blacklist filter stops content from known blacklisted sources and senders. Rule-based filters stops content that satisfy specific rules such as certain senders with specific words in the content body.

In further implementations, the classification module 260 labels the content 310 in three categories: spam content, low quality spam content, or not spam. Within the spam content category, the classification module 260 further flags the content 310 with spam type identifiers including, but not limited to: adult, money fraud, phishing, malware, commercial spam, hate speech, harassment, outrageously shocking, and the like. Within the low quality content category, the classification module 260 further flags the content 310 with low quality identifiers, including, but not limited to: adult (the level of low quality adult is not as outrageous as compared to the spam type adult), commercial promotions, unprofessional, profanity, shocking, and the like. For each labeled content, the classification module 260 calculates an associated accuracy score regarding the confidence level of the content it labeled. An accuracy score determines how well the spam model employed by the classification module 260 correctly identifies or excludes spams using accuracy statistics, where accuracy=(number of true positives+number of true negatives)/(number of true positives+false positives+false negatives+true negatives). The process of calculating an accuracy score is further detailed below in association with FIG. 4.

The classification module 260 sends the labeled content 310 to the decision module 240. Based on the labeled content 310 and associated accuracy score from the classification module 260, the decision module 240 determines whether to send the labeled content 310 to the tagging module 330, or the review module 340, or both for further review as further discussed in detail below. The tagging module 330 is used for data collection and labelling content for use in training new machine learning spam filtering models. As such, the tagging module 330 receives both types of content, spam and not spam, whereas the review module 340 receives content labeled by the classification module 260 is questionable, and the content may or may not potentially be spam. Further, all other determined spam content not sent to the review module 240 with an associated high accuracy score above a predetermined threshold is determined to be spam and the decision module 240 filters the spam content.

The decision module 240 receives labeled content 310 from the classification module 260 and identifies a general sampling data set and positive sampling data set and sends to the tagging module 330. The decision module 240 identifies a general sampling data set from the labeled content by randomly sampling across labeled spam and non-spam content. Each content has an associated metadata that identifies the labeled content as spam, low quality spam, or not spam content, the labeling being performed by the classification module 260 as discussed above. The general sampling data set is a predetermined percentage of randomly selected content from the labeled content irrespective of the outcome from the classification module 260. Therefore, the general sampling data set contains all labeled content, including spam and not spam content. The decision module 240 identifies a positive sampling data set from the labeled content by randomly sampling only across content labeled as spam or low quality spam by the classification module 260. The positive sampling data set is a predetermined percentage of the content labeled as spam or low quality spam by the classification module 260. Further, where the accuracy score falls within a predetermined range, the decision module 240 also sends the content 310 to the tagging module 330 for data collection and further labelling purposes. As a result, the tagging module 330 receives a general sampling data set, a positive sampling data set, and content with an associated accuracy score that falls within a predetermined range.

In various embodiments, the decision module 240 determines whether the labeling of the content 310 by the classification module 260 is questionable and therefore will be sent to the review module 340. The labeling of a content determined to be questionable would be sent for review by an expert reviewer. The determination by the decision module 240 that a spam or non-spam type labelling is questionable relies on predetermined rules that flag the labels as potentially erroneous due to detected inconsistencies. Predetermined rules for determination whether a labeled content is questionable depends on information associated with the author of the content including, author status, account age, number of connections on an online social network (e.g., for example, number of direct connection on LinkedIn profile), reputation score of the author, past articles published by the author, and the like. A reputation score of the author can be the sum of the number of endorsements, number of likes on a published article, and number of followers. The higher the reputation score, the more unlikely the content by the author is spam. For example, inconsistencies include a content flagged as spam type of low quality spam type but originating from a member with status as a influencer, the member has an active account above a threshold number of years, the member has a number of direct connections above a threshold number of accounts, or if the member has published a number of other articles in the past. Such inconsistencies resulting in questionable labeling leads to the content being sent to the review module 340 as further discussed below.

In another example, if the source of the content 310 comes from a member with influencer status, then the content 310 is unlikely spam. In this example, if an article has a source identifier being a post from a member who is an influencer within a professional network is labeled by the classification module 260 as low quality spam with low quality spam type identifier promotions would be flagged by the decision module 240 as questionable. A member who has an influencer status are those who have been officially invited to publish on a social network (e.g., for example LinkedIn) due to their status as leaders in the industries. Therefore, an article being published by a member who holds an influencer status being marked as low quality spam type is questionable and therefore sent to the review module 340 for further review.

In yet another example, the older the author's member account age, the less likely the content by the author is spam. Therefore, if the content is labeled as spam by the classification module 260 and the author of the content has a member account more than a predetermined threshold number of years, the content is labeled as questionable by the decision module 240 since it is unlikely spam content. In other examples, the higher the number of connections the author has in his online social network profile or the highest the number of past articles the author has published, the less likely the content by the author is spam. Therefore, if the content is labeled as spam by the classification module 260 and the author of the content has a member account with more than a predetermine threshold number of connections, the content is labeled as questionable (based on predetermined rules as further discussed below) by the decision module 240 since it is unlikely spam content. Similarly, if the content is labeled as spam by the classification module 260 and the author of the content has a member account with a number of past articles published more than a predetermined threshold, the content is labeled as questionable by the decision module 240 since it is unlikely spam content. Questionable content is sent to the review module 340 for further review as fully described below in association with FIG. 3.

In various embodiments, the determination of the decision module 240 to send the content 310 to the tagging module 330 or the review module 340 is independent of each other. Sending the content 310 to the tagging module 330 depends on the accuracy score associated with the label of 310 as spam, low quality span, or not spam type falling within a predetermined range. Sending the content 310 to the review module 340 depends on how questionable the label of 310 is based on sets of predetermined rules. As a result, a single content 310 can be simultaneously sent to tagging module 330 (if the accuracy score falls within the predetermined range) and the review module 340 (if the label is questionable). Continuing with the example above, where the article having a source identifier being a post from a member who is an influencer is labeled by the classification module 260 as low quality spam can have an associated accuracy score of 63%, where the predetermined range is 0%-65%. In this example, is further sent to the tagging module 330 since the accuracy score falls within the predetermined range. Further discussion of each of the tagging module 330 and review module 340 is detailed below.

The tagging module 330 receives the content 310 from the decision module 240 for further review by internal reviewers. Internal reviewers qualified to review and label the content. To ensure minimal noise contributed by multiple different internal reviewers labeling content, internal reviewers are required to pass a labeling test before qualifying as an internal reviewer. For example, internal reviewers who can label content with 95% accuracy in the labeling test are allowed to qualify as internal reviewers for reviewing content sent to the tagging module 330. The classification results made by the tagging module 330 is further used as part of the training data set for the machine learning module 260 as discussed in detail in FIG. 4.

The review module 340 receives the labeled content 310 from the decision module 240 for further review by experts. The labeling of the content 310 by the classification module 260 was determined to be questionable by the decision module 240 and thus sent to the review module 340. A labeled content 310 is determined questionable where the label assigned to the content by the classification module 260 is potentially inconsistent with existing information by the source of the content (e.g., the person who authored the content and the information associated with the author). The review module 340 provides functionality to create an interactive user interface to present to expert reviewers the content 310 and associated information including the labeled spam category, spam type, associated accuracy score for the label, content source, date of content creation, and the like. Expert reviewers are in the form of experts trained to identify spam with high accuracy. In some embodiments, expert reviewers are internal reviewers who have labeled content with 90% accuracy and above for a predetermined time period, such as one year.

The interactive user interface receives a verification mark made by expert reviewers on whether the content 310 is correctly labeled by the classification module 260, and if incorrect, the correct spam category is selected and updated. As discussed, the three categories for labelling including spam, low quality spam, and not spam. Within the spam category label, the expert reviewer can select the spam type identifiers, including, but not limited to: adult, money fraud, phishing, malware, commercial spam, hate speech, harassment, outrageously shocking, and the like. Within the low quality content category, the expert reviewer can select the low quality identifiers, including, but not limited to: adult (the level of low quality adult is not as outrageous as compared to the spam type adult), commercial promotions, unprofessional, profanity, shocking, and the like. The category label and spam type identifiers and low quality identifiers can be presented to the expert reviewer as a selection. In an example, continuing with the above example of the article posted by the influencer member labeled as low quality spam by the classification module 260 will be corrected by the expert reviewer as an incorrect label and update the label as not spam content. The impact of the updated re-labeling made by the expert reviewer has an impact on the live filtering of contents. As such, once the review module 340 receives the update that the content is not spam, the information is updated and the spam processing system does not filter the content updated as not spam. Likewise, if the review module 340 receives the update that the content is spam, the information is updated and the spam processing system filters the content as spam, as labeled by an expert reviewer. Unlike the updated re-labeling received by the review module 340, and re-labeling received by the tagging module 330 has no impact on whether the current content is filtered or not. In other words, the re-labeling at the review module 340 is applied to the active live filtering by the spam processing system. However, the re-labeling at the tagging module 330 has no impact on the live filtering mode. In this way, the tagging module 330 has the purpose of data collection and labelling.

The individual tagging module 350 provides functionality to receive spam labelling from individual users of the social network. Individual users can mark each content as spam, the type of spam, and can further provide comments when labelling the content. The individual tagging module 350 further provides an interactive user interface for users to label contents as spam. For example, when a user receives an advertisement email in their inbox, the user can label the email as a spam and optionally identify the spam type as commercial spam. The selectable interface of label categories, spam type identifiers, and low quality identifiers presented to the expert reviewers associated with the content are also presented to the user.

In various embodiments, a selectable interface is presented to the user in response to the user indicating an intent to mark the content as spam. The labelling made by individual users are reviewed by the individual tagging module 350. Each content, having a unique content identification, have a corresponding count of the number of individual users that have marked the content as spam or low content spam. Individual user labelling is potentially noisy due to inaccuracies of individuals differentiating quality content from real spam content. Therefore, the labels of individual users labelling are subsequently assigned less weight during training a machine learning model as discussed in detail in FIG. 4. In other embodiments, these individual users can be individual people from a broad online community (e.g., via crowdsourcing) and not limited to users of a social network. These spam labeling can be specifically requested through the use of crowd-based outsourcing utilizing crowdsourcing platforms such as CrowdFlower, in one example. The spam labeling of content by individual users from the social network and individual people from crowd-based outsourcing is stored in the database 380.

In some embodiments, the database 380 receives, maintains, and stores labeled content from various modules of the spam processing system 200, including the classification module 260, tagging module 330, review module 340, and individual tagging module 350. In an example, the database 380 stores the content in a structured format, categorizing each content with the spam categorizing (i.e., spam, low level spam, not spam) decision by each module along with associated spam type identifiers, comments, URN of the content source, content language, and the like.

FIG. 4 is a block diagram illustrating an example for building, training, and updating machine learning spam processing models. The machine learning module 250 receives labeled content from the database 380 to build and train candidate models for spam processing at operation 410. In some embodiments, a predefined number of labeled data from the database 380 are used to train candidate models. The predefined number of labeled data is configurable and can be determined by the number of labeled data required for a new candidate model to function differently than the current active model. For example, the machine learning module 250 receives N number of new labeled data to train a candidate model. However, after testing the candidate model, the candidate model does not function differently than the current active model, the predefined number of labeled data N can be reconfigured to receive additional labeled data. The N number of new labeled data are obtained from the database 380, storing data from the tagging module 330 (e.g., updated labeling by internal reviewers for the general sampling data set, positive sampling data set, and content with an associated accuracy score that falls within a predetermined range), review module 340 (updated labeling by expert reviewers for labeling of content determined to be questionable), and individual tagging module 350 (content labeled by individual users of an online social network or broad online community via crowdsourcing).

In other embodiments, relevant labeled data from database 380 are used to train candidate models. Relevant labeled data are determined by date, labeled data from each module, categorize type, spam type identifiers, and the like. In an example, labeled data from a certain time frame window are filtered to train candidate models, where the time frame window moves as new data is collected. In this way new labeled data are used and older labeled data are not. In another example, labeled data from each module are filtered to acquire a balance in the different module sources such as tagging module 330, review module 340, or individual tagging module 350.

In further embodiments, after the candidate models are trained with new labeled data, the candidate models are tested and a performance score is calculated for each candidate model at operation 420. A performance score is also calculated for the current active model at the classification module 260. The performance score is calculated by using statistical measurements including F-measure, receiver operating characteristic-area under the curve (ROC-AUC), or accuracy.

In example embodiments, F-measure is an evaluation of a model's accuracy score, considering both precision and recall of the model. Precision is the number of correctly identified positive results (correctly identified labeled content by the model as spam, low quality spam, or not spam) divided by the number of all positive samples (the actual label of the content). Recall measures the proportion of positives that are correctly identified as such. Thus, recall is the number of true positive divided by the number of true positive and the number of false negatives. For example, recall is calculated as the number of general content (e.g., from the general sampling data set) marked as spam which were marked as spams by reviewers as well (e.g., correct positive results) divided by the total number of general content that were marked as spam by reviewers. In a specific example, the F-measure is calculated as follows: F-measure=2(precision×recall)/(precision+recall).

In example embodiments, ROC-AUC is used to compare candidate models. The ROC curve is a graphical plot that illustrates the performance of candidate models, created by plotting the true positive rate against the false positive rate. The area under the curve (AUC) of each ROC curve is calculated for model comparison.

In example embodiments, accuracy score statistics measurement is used to determine how well a candidate model correctly identifies or excludes spams. For example, accuracy is the proportion of true results (e.g., both true positives and true negatives) among the total number of content examined. In a specific example, the accuracy score is calculated as follows: accuracy=(number of true positives+number of true negatives)/(number of true positives+false positives+false negatives+true negatives).

The candidate model with the highest performance score is selected to be compared with the performance score of the current active model at operation 430. A model with a higher performance score is determined to function better at spam filtering. If the candidate model within the machine learning module 250 is determined to function better than the current active model, the high scoring candidate model is sent to the classification module 260 and applied as the new active model. Any new spam filtering model that is considered by the machine learning module 250 to score higher than the current active model (e.g., thus better at filtering spam than the current model) is then used by the classification module 260. However, if the candidate model does not function better than the current active model, then the model is sent back to the model building and data training step 410 for further data training with more labeled data. In this way, the candidate models within the machine learning module 250 are in a passive mode while being trained and tested and therefore does not have any effect on the active spam filtering.

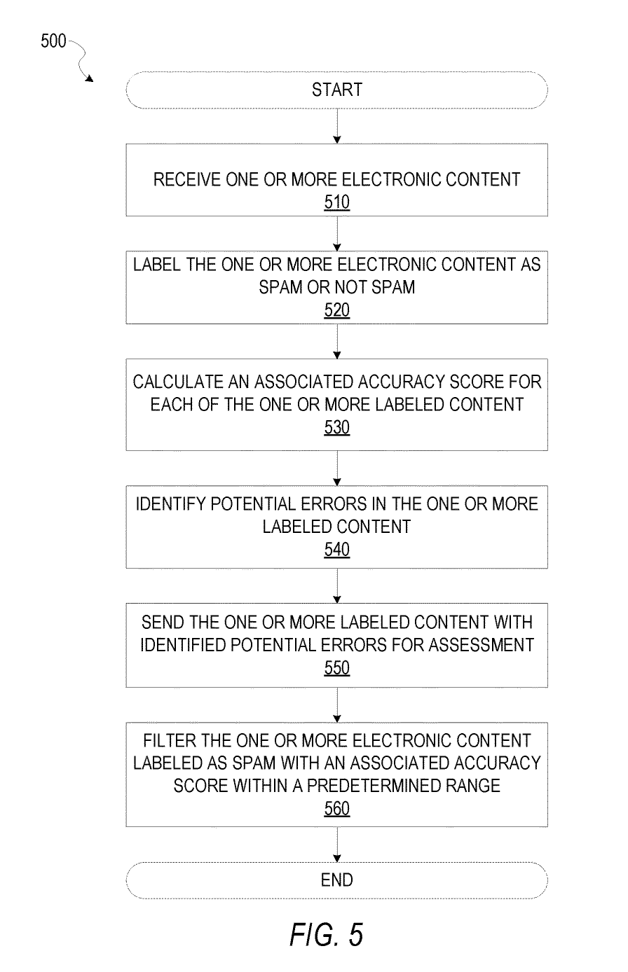

FIG. 5 is a flow diagram illustrating an example method 500 for building and training spam processing filters, according to example embodiments. The operations of the method 500 may be performed by components of the spam processing system 200. At operation 510, the classification module 260 receives one or more electronic content. The decision module 240 sends the one or more electronic content to the classification module 260 for labeling.

At operation 520, the classification module 260 labels the one or more electronic content as spam or not spam, the classification module 260 employing the current spam filtering system to label the content. The classification module 260 labels the content 310 in three categories: spam content, low quality spam content, or not spam. The spam content and low quality spam content are both spam, but differing degrees of spam. Further details regarding the labeling of electronic content have been discussed in detail in association with FIG. 2 and FIG. 3 above.

At operation 530, the classification module 260 calculates an associated accuracy score for each of the one or more labeled content. An accuracy score determines how well the spam model employed by the classification module 260 correctly identifies or excludes spams using accuracy statistics. The process of calculating an accuracy score is further detailed in association with FIG. 4. The labeled content and the associated accuracy score is sent to the decision module 240.

At operation 540, the decision module 240 identifies potential errors in the one or more labeled content based on the label of the one or more labeled content being inconsistent with information associated with the source of the one or more labeled content. The detected inconsistency leads the labeling of the content by the classification module to be questionable and therefore flagged for further review by an expert reviewer at the review module 340. Predetermined rules for determination whether a labeled content is questionable (e.g., thus a detected inconsistency) depends on information associated with the source of the one or more labeled content. The source is the originator of the content, such as an author of the content. Such information associate with the content source includes, but not limited to, author status, account age, number of connections on an online social network (e.g., for example, number of direct connection on LinkedIn profile), reputation score of the author, past articles published by the author, and the like. At operation 550, the decision module 240 sends the one or more labeled content with identified potential errors for assessment by expert reviewers at the review module 340. Further details of the inconsistencies of the content label with the source information is further detailed below in association with FIG. 2 and FIG. 3.

At operation 560, the decision module 240 filters the one or more electronic content labeled as spam with an associated accuracy score within a predetermined range, excluding labeled content with identified potential errors. At this stage of the operation, the labeled content with the identified potential errors are not acted upon until there is review by an expert reviewer at the review module 340. The remaining electronic content not awaiting expert review and are labeled as spam with an associated accuracy score within a predetermined range are filtered. The accuracy score within a predetermined range show a high confidence level of the spam label and therefore likely spam.

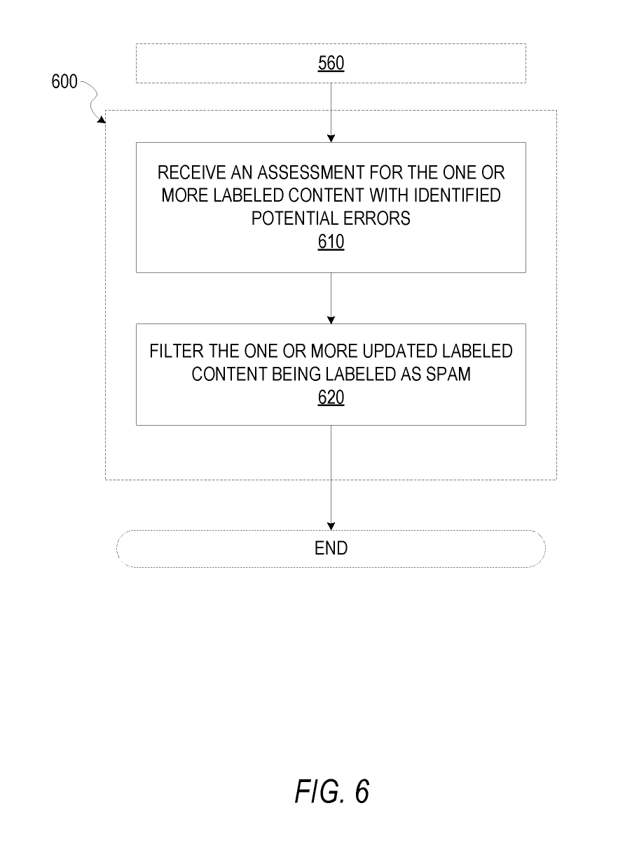

FIG. 6 is a flow diagram illustrating an example method 600 for updating labeled content by expert reviewers, according to example embodiments. The operations of the method 600 may be performed by components of the spam processing system 200. At operation 610, the review module 340 receives an assessment for the one or more labeled content with identified potential errors, the assessment comprising updating the label of the one or more labeled content with identified potential errors. The review module 340 presents a user interface for expert reviewers to label the content with detected inconsistencies (e.g., questionable content). The user interface presents other information associated with the content, such as source, date of content creation, the actual content, and the like. After review, the labeling of the content is updated by expert reviewers and sent to the decision module 240. At operation 620, in response to receiving the updated labeled content, the decision module 240 filters the one or more updated labeled content being labeled as spam. Further, the updated labeled content are also subsequently used to train new machine learning spam filtering models.

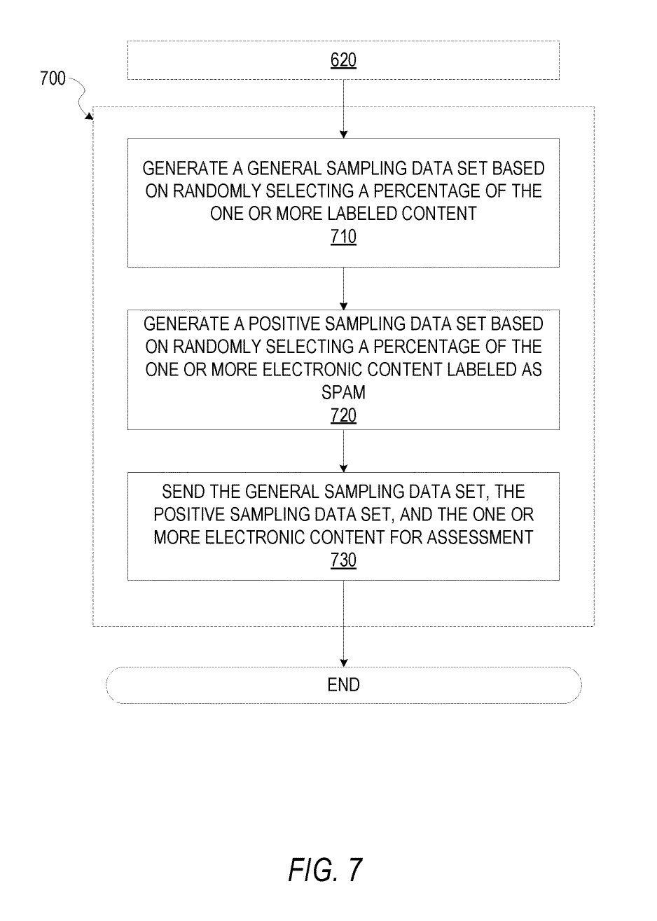

FIG. 7 is a flow diagram illustrating an example method 700 for data collection and labelling content for use in training new machine learning spam filtering models, according to example embodiments. The operations of the method 700 may be performed by components of the spam processing system 200. At operation 710, the decision module 240 generates a general sampling data set based on randomly selecting a percentage of the one or more labeled content. The general sampling data set is a predetermined percentage of randomly selected content from the labeled content irrespective of the outcome from the classification module 260. Therefore, the general sampling data set contains all labeled content, including spam and not spam content.

At operation 720, the decision module 240 generates a positive sampling data set based on randomly selecting a percentage of the one or more electronic content labeled as spam. Therefore, the positive sampling data set contains content positively labeled by the classification module 260 as spam. Here, spam includes low quality spam content.

At operation 730, the decision module 240 sends the general sampling data set, the positive sampling data set, and the one or more electronic content with an associated accuracy score within a second predetermined range for assessment at the tagging module 330 by internal reviewers. The internal reviewers review the content and update the labeling of the content where appropriate. The one or more electronic content with an associated accuracy score within a second predetermined range. The accuracy score within a second predetermined range can be for example a range where the accuracy is low, such as a range between 0%-65%. Such a range signifies low confidence in the labelling and therefore should be reviewed at the tagging module for further data collection and subsequent machine learning spam filtering model. The second predetermine range reflects low accuracy in order to train better spam filtering models when compared to the current model.

### Modules, Components, and Logic

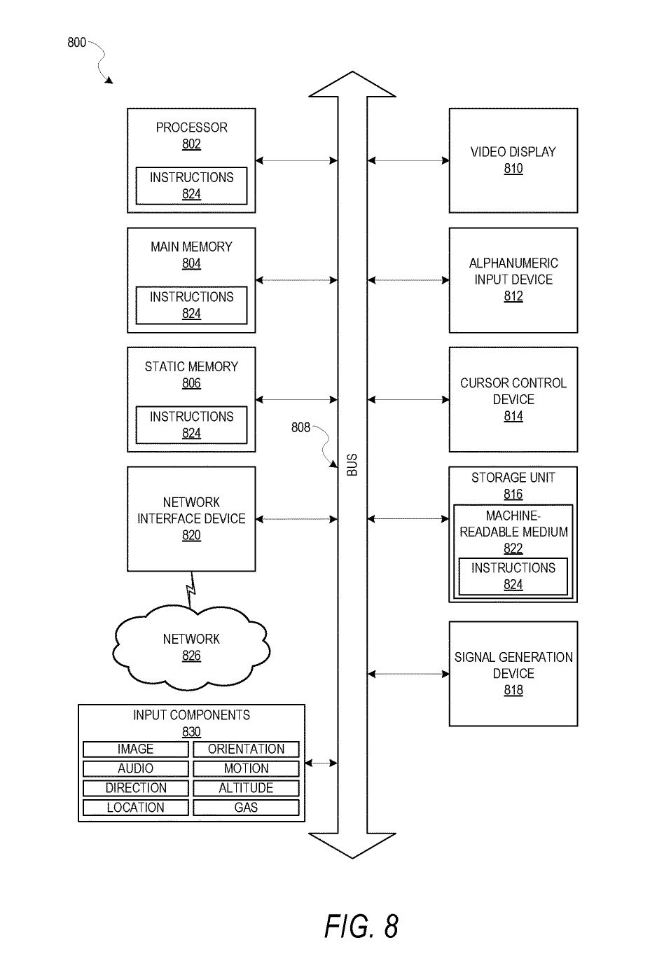

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies, associated with the service provider system 200, discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Any of these machines can execute the operations associated with the service provider system 200. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or all three, during execution thereof by the machine 800. Accordingly, the main memory 804, static memory 806 and the processor 802 may be considered as machine-readable media 822. The instructions 824 may be transmitted or received over a network 826 via the network interface device 820.

In some example embodiments, the machine 800 may be a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instruction 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labeling the machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks (e.g. 3GPP, 4G LTE, 3GPP2, GSM, UMTS/HSPA, WiMAX, and others defined by various standard setting organizations), plain old telephone service (POTS) networks, and wireless data networks (e.g., WiFi and BlueTooth networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a processor, and a memory including instructions, which when executed by the processor, cause the processor to:
receive one or more electronic content label, by a current spam filtering system, the one or more electronic content as spam or not spam;
calculate an associated accuracy score for each of the one or more labeled content;
identify potential errors in the one or more labeled content based on the label of the one or more labeled content being inconsistent with information associated with the source of the one or more labeled content;
send the one or more labeled content with identified potential errors for assessment; and
filter the one or more electronic content labeled as spam with an associated accuracy score within a predetermined range, excluding labeled content with identified potential errors.

2. The system of claim 1, further comprising:
receive an assessment for the one or more labeled content with identified potential errors, the assessment comprising updating the label of the one or more labeled content with identified potential errors; and
filter the one or more updated labeled content being labeled as spam.

3. The system of claim 2, further comprising:
generate a general sampling data set based on randomly selecting a percentage of the one or more labeled content;
generate a positive sampling data set based on randomly selecting a percentage of the one or more electronic content labeled as spam; and
send the general sampling data set, the positive sampling data set, and the one or more electronic content with an associated accuracy score within a second predetermined range for assessment.

4. The system of claim 3, further comprising:
receive an assessment for the one or more labeled content with an associated accuracy score within a second predetermined range, the assessment comprising updating the label of the one or more labeled content.

5. The system of claim 4, further comprising:
receive electronic content being labeled as spam or not spam from individual users.

6. The system of claim 5, further comprising:
train a potential spam filtering system using the updated labeled content with potential errors, general sampling data set, positive sampling data set, updated labeled content with an associated accuracy score within a second predetermined range, and labeled content from individual users.

7. The system of claim 6, further comprising:
calculate a performance score for the potential spam filtering system using precision and recall measurements.

8. The system of claim 7, further comprising:
calculate a performance score for the current spam filtering system using precision and recall measurements;
compare the performance score of the current spam filtering system and the performance score of the potential spam filtering system; and
based on the performance score of the potential spam filtering system exceeding the performance score of the current spam filtering system, implement the potential spam filtering system for filtering incoming content.

9. A method comprising:
using one or more computer processors:
receiving one or more electronic content
labeling, by a current spam filtering system, the one or more electronic content as spam or not spam;
calculating an associated accuracy score for each of the one or more labeled content;
identifying potential errors in the one or more labeled content based on the label of the one or more labeled content being inconsistent with information associated with the source of the one or more labeled content;
sending the one or more labeled content with identified potential errors for assessment; and
filtering the one or more electronic content labeled as spam with an associated accuracy score within a predetermined range, excluding labeled content with identified potential errors.

10. The method of claim 9, further comprising:
receiving an assessment for the one or more labeled content with identified potential errors, the assessment comprising updating the label of the one or more labeled content with identified potential errors; and
filtering the one or more updated labeled content being labeled as spam.

11. The method of claim 10, further comprising:
generating a general sampling data set based on randomly selecting a percentage of the one or more labeled content;
generating a positive sampling data set based on randomly selecting a percentage of the one or more electronic content labeled as spam; and
sending the general sampling data set, the positive sampling data set, and the one or more electronic content with an associated accuracy score within a second predetermined range for assessment.

12. The method of claim 11, further comprising:
receiving an assessment for the one or more labeled content with an associated accuracy score within a second predetermined range, the assessment comprising updating the label of the one or more labeled content.

13. The method of claim 12, further comprising:
receiving electronic content being labeled as spam or not spam from individual users.

14. The method of claim 13, further comprising:
training a potential spam filtering system using the updated labeled content with potential errors, general sampling data set, positive sampling data set, updated labeled content with an associated accuracy score within a second predetermined range, and labeled content from individual users.

15. The method of claim 14, further comprising:
calculating a performance score for the potential spam filtering system using precision and recall measurements.

16. The method of claim 15, further comprising:
calculating a performance score for the current spam filtering system using precision and recall measurements;
comparing the performance score of the current spam filtering system and the performance score of the potential spam filtering system; and
based on the performance score of the potential spam filtering system exceeding the performance score of the current spam filtering system, implementing the potential spam filtering system for filtering incoming content.

17. A machine-readable medium not having any transitory signals and storing instructions that, when executed by at least one processor of a machine, cause the machine to perform operations comprising:
receiving one or more electronic content
labeling, by a current spam filtering system, the one or more electronic content as spam or not spam;
calculating an associated accuracy score for each of the one or more labeled content;
identifying potential errors in the one or more labeled content based on the label of the one or more labeled content being inconsistent with information associated with the source of the one or more labeled content;
sending the one or more labeled content with identified potential errors for assessment; and
filtering the one or more electronic content labeled as spam with an associated accuracy score within a predetermined range, excluding labeled content with identified potential errors.

18. The machine-readable medium of claim 17, wherein the operations further comprise:
receiving an assessment for the one or more labeled content with identified potential errors, the assessment comprising updating the label of the one or more labeled content with identified potential errors; and
filtering the one or more updated labeled content being labeled as spam.

19. The machine-readable medium of claim 18, wherein the operations further comprise:
generating a general sampling data set based on randomly selecting a percentage of the one or more labeled content;
generating a positive sampling data set based on randomly selecting a percentage of the one or more electronic content labeled as spam; and
sending the general sampling data set, the positive sampling data set, and the one or more electronic content with an associated accuracy score within a second predetermined range for assessment.

20. The machine-readable medium of claim 19, wherein the operations further comprise:
receiving an assessment for the one or more labeled content with an associated accuracy score within a second predetermined range, the assessment comprising updating the label of the one or more labeled content.
